(19) United States
(12) Patent Application Publication
(10) Pub. No.: US 2022/0140384 A1
(43) Pub. Date: May 5, 2022

(54) All Solid Anode Array and Nano-Clay Electrolyte and Cathode

(71) Applicant: Darkeyah Reuven, ATLANT, GA (US)

(72) Inventor: Darkeyah Reuven, ATLANT, GA (US)

(21) Appl. No.: 17/089,082

(22) Filed: Nov. 4, 2020

(51) Int. Cl. H01M 10/058; H01M 10/0562; H01M 4/62; H01M 4/485; H01M 10/48

(52) U.S. Cl. CPC H01M 10/058; H01M 10/0562; H01M 10/48; H01M 4/485; H01M 4/628

(57) ABSTRACT

All solid battery composed of anode array organic/nano-clay (layered mineral aluminosilicate)/metal layered electrolyte and cathode.

### CROSS-REFERENCE TO RELATED APPLICATIONS

N/A

### FIELD OF THE DISCLOSURE

The present disclosure generally relates to ion chemical power delivery with solid electrolyte material.

### BACKGROUND OF THE DISCLOSURE

Current batteries utilize liquid fluorocarbon electrolyte material. Unfortunately, these organic liquids have combustibility safety issues; and form reaction byproducts at the anode and cathode interface which limit performance. The present disclosure provides remedies to the stated limitations.

### BRIEF SUMMARY OF THE DISCLOSURE

The solid electrolyte battery (SEB) comprises: (a) anode array (AA); (b) nano-clay solid electrolyte (NCSE); (c) nano clay cathode (NCC); (d) cyano organic interface material (COIM); (e) and the continuity electrodes array (CEA).

In one embodiment, and the nano-clay solid electrolyte (NCSE), comprises nano-clay (NC, layered mineral aluminosilicate) such as, kaolinite and/or bentonite and/or montmorillonite and/or hectorite and/or laponite and/or vermiculite and/or saponite material; in one embodiment the nano-clay and organic material can intercalate and/or chelate atomic and/or nano and/or clusters of cesium (Ce) and/or lithium (Li) and/or sodium (Na) and/or bismuth (Bi) and/or tin (Sn) and/or silicon (Si).

In one embodiment, the nano clay cathode (NCC), comprises nano-clay such as, kaolinite and/or bentonite and/or montmorillonite and/or hectorite and/or laponite and/or vermiculite and/or saponite material; in one embodiment the nano-clay and organic material can intercalate and/or chelate atomic and/or nano and/or clusters of chlorine (Cl), and/or bromine (Br), and/or sulfur (S) and/or bismuth (Bi) and/or tin (Sn) and/or silicon (Si) and/or iodine (I) and/or selenium (Se).

In one embodiment, the anode array (AA) can be parallel and/or serially electrically connected copper (Cu) and/or aluminum (Al) printed/patterned circuit board (PCB) array on which is deposited active metal (AM). In one embodiment the AM can be Li and/or Na and/or magnesium (Mg) and/or Al and/or iron (Fe) can be deposited.

In one embodiment, the continuity electrodes array (CEA) can be parallel and/or serially electrically connected copper (Cu) and/or aluminum (Al) and/or carbon (C) and/or graphene array. These CEAs are separated from the AA by ˜10-30 um of COIM and/or NCSE material. The plurality of CEA provide electrical continuity detection from the AA and between the AA and the NCC, due to dendrite growth between the AA and CEA; or the AA and NCC. In one embodiment, the CEAs and/or AA can be electronically controlled, independently and/or collectively, by computer program(s) to effect continuity detection between the AA to CEA, or AA to NCC, and to effect AM deposition and redisbursement between AA pads. The AA and CEA array, in one embodiment, is composed of metal vapor deposition or laser etched cut out pattern of Aluminum foil and/or copper foil and/or carbon paper.

In one embodiment, cyano organic interface material (COIM) in the SEB comprises cyanide materials, such as Potassium ferrocyanide (Potassium hexacyanoferrates), Sodium ferrocyanide, calcium ferrocyanide, lithium ferrocyanide, chromium hexacyanoferrates and cobalt hexacyanoferrates, polycyanoacrylate and cyano functionalized polymers/saccarides; or Ethylenediaminetetraacetic acid; the COIM can chelate and/or intercalate with Sn and/or Bi and/or Si; in the SEB the COIM act as an interface material between the AA and NCSE, also the NCSE and NCC.

### BRIEF DESCRIPTION OF THE FIGURES

The following figures all solid cell (ASC) are by way of illustration purposes only, and thus are not intended to limit the scope of the present disclosure.

FIG. 1. a) Schematic of an example of the all solid cell (ASC) showing ion filled nano clay cathode (NCC) mixed with graphene, (500 μm); anode array (AA) (200 μm); and high surface area nano-clay solid electrolyte (NCSE) (200 μm); b) and nano-clay, layered mineral aluminosilicate material, which prevents aggregation of intercalated with atomic and/or nano and/or clusters of cesium (Ce). lithium (Li) and/or sodium (Na).

FIG. 2. Anode array (AA) printed circuit board (PCB) array; and associated continuity electrodes array (CEA).

FIG. 3. A) Ionic conductivity of lithium (Li) and sodium (Na) through the nano-clay solid electrolyte (NC SE). B) Electrochemical impedance spectroscopy (EIS) of an example of a solid electrolyte cell with Bi/Cl/S—NCC cathode (20% graphene), and lithium metal anode; and nano-clay solid electrolyte (NCSE).

Table 1: Sulfur crosslinked Species (SCS) molecular formulas

### DETAILED DESCRIPTION OF THE DISCLOSURE

The present disclosure provides for an all solid state battery.

The NCSE is composed of dense particle network, which is configured such that ions diffuse into and out of the porous NCSE and NCC during charging and/or discharging of the battery.

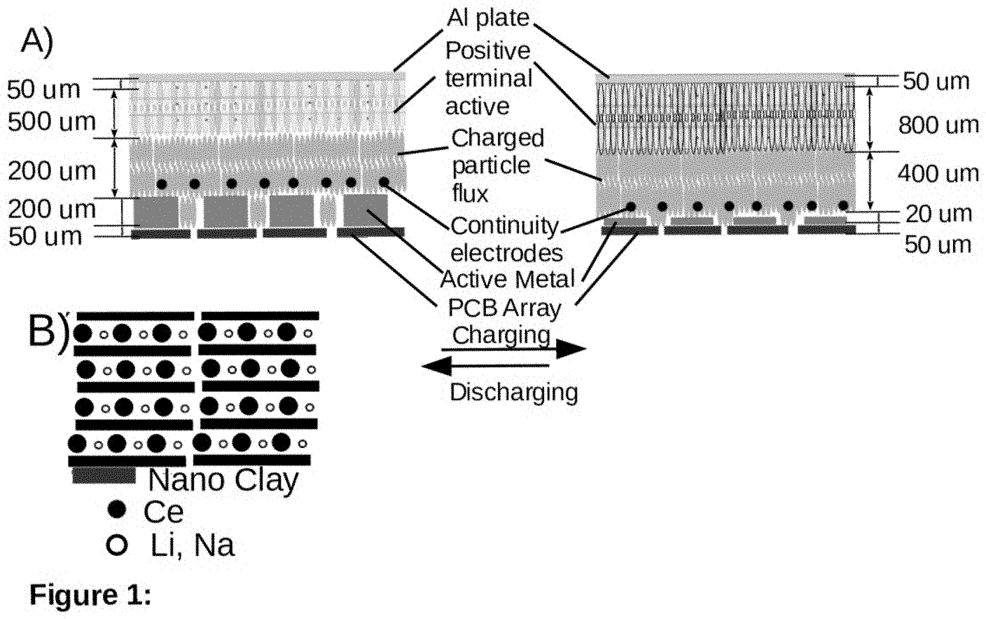

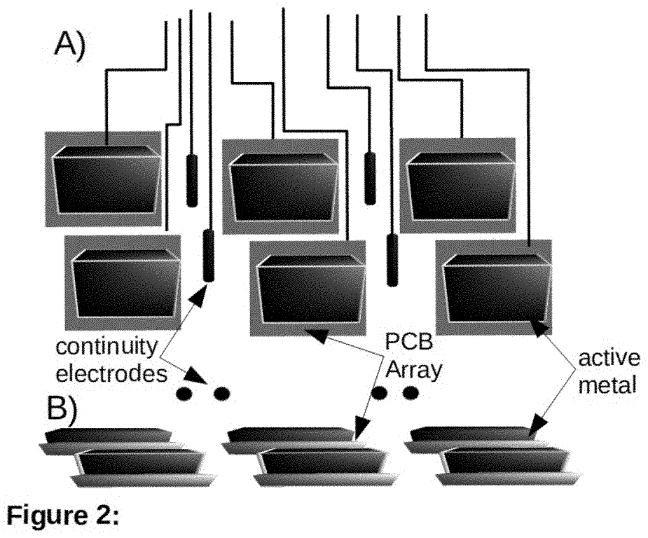

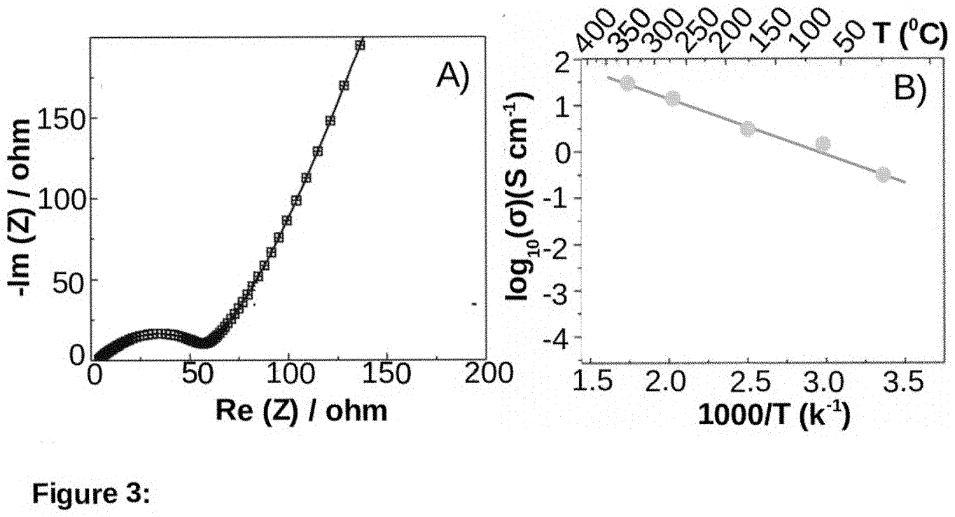

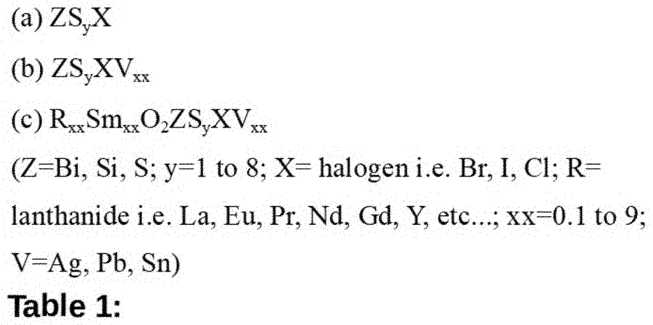

The solid electrolyte cell has the advantage over current battery's, in that the solid electrolyte material is providing improved safety, and also provides increase stability to facilitating high voltage electrodes for higher energy density. The battery design (FIG. 1) provides added benefits in that it facilitates a thin solid battery, both resulting in lower resistance and thus higher power and energy density. Also, the structure reduces mechanical strain during ion intercalation during charging and discharging cycles, thus improving the lifetime of battery technology.

In one embodiment, electrically conductive material as a conductive matrix is mixed with the NCC material. In one embodiment, the NCC material is composed of nano-clay interfaced with non-intercalated and non-intercalated with conductive graphite/carbon, and COIM. In one embodiment, the nano-clay can have intercalated atom and/or clusters of tin (Sn) and/or sulfur (S) and/or silicon (Si) and/or bismuth (Bi) and/or cesium (Ce) and/or selenium (Se) and/or Samarium (Sm); and/or halogens, including but not limited to, iodine (I), bromine (Br) and/or chlorine (Cl) and/or lanthanides, including but not limited to, lanthanum (La), and/or Europium (Eu), and/or praseodymium (Pr), and/or neodymium (Nd), and/or Yttrium (Y), gadolinium (Gd) etc. In one embodiment S₈, also NaCl, LiCl, NaI, LiI, NaBr, and/or LiBr and other salts can be mixed with the NCC in preparation steps. In one embodiment, the Sn, Sm, Bi, Si, I, Br, and/or Cl can crosslink with sulfur, to form various sulfur crosslinked species (SCS) (see Table 1: a, b, c). The SCS are fixed within the nanoclay/carbon composite and reversibly form complex salt species with Na and/or Li. In one embodiment, the cyano organic interface material (COIM) interfaced with the NCC can chelate and bind atom and/or clusters of Sn, Bi and/or Si.

The porous structure of the NCC and NCSE has microstructural features (e.g., microporosity) and/or nanostructural features (e.g., nanoporosity). For example, each porous particle, independently, has a porosity of 10% to 90%, including all integer % values and organic/metal/clay. In another example, each porous particle, independently, has a porosity of 40% to 80%. The porous particle (e.g., organic/metal/clay) provide structural support to the dense organic/metal/clay so that the thickness of the dense organic/metal/nano-clay can be reduced, thus reducing its resistance.

The NCC and NCSE material can be systematically synthesized by solid or liquid mixing techniques. For example, a mixture of starting materials may be mixed in an organic solvent (e.g., water, ethanol or methanol) and the mixture of starting materials dried to evolve the organic solvent. The mixture of starting materials may be ball milled. The ball milled mixture may be calcined. For example, the ball milled mixture is calcined at a temperature between 400° C. to 1999° C., including all integer ° C. The calcined mixture may be sintered. For example, the calcined mixture is sintered at a temperature between 400° C. to 1999° C. To achieve the prerequisite particle size distribution, the calcined mixture may be milled using a technique such as vibratory milling, attrition milling, jet milling, ball milling, or another technique known to one of ordinary skill in the art.

One of ordinary skill in the art would understand that a number of conventional fabrication processing methods are known for processing. Such methods include, but are not limited to, casting, calendaring, embossing, punching, cutting, slip casting, gel casting, die casting, solvent bonding, lamination, heat lamination, pressing, isostatic pressing, hot isostatic pressing, uniaxial pressing, extrusion, co-extrusion, centrifugal casting, and sol gel processing. The resulting composite material may then be thermally processed in air, or controlled atmospheres to decrease loss of individual components. In some embodiments of the present invention it is advantageous to fabricate solid materials by die-pressing, optionally followed by isostatic pressing. In other embodiments it is advantageous to fabricate using a combination of methods such as punching, casting, cutting, heat lamination, solvent bonding, or other techniques known to one of ordinary skill in the art.

A critical problem in the fabrication of all-solid-state lithium batteries is Li and Na metal anodes and solid electrolytes exhibit poor ionic and electronic contact resulting in interfacial resistance.

The COIM chelated with semimetal bismuth (COIM-Bi) significantly improved the electrochemical performance of the all solid cell by reduction of the interfacial resistance between the metal anode and the NCC. Thermodynamic calculations suggest that the effective contact between lithium metal and lithium bismuth is increased by the formation of Li—Bi or Na—Bi species at the interface.

The COIM chelated with semimetal bismuth (COIM-Bi) has high thermal and redox stability when interfaced at the metal anode array; due to bismuth low thermal conductivity. Additionally, the chelated Bi and/or Si within the COIM nanocomposite readily alloys with Li and Na leading to fracturing of the Bi or Si cluster. The fracturing of the Bi or Si clusters increases the chelate surface area, decreasing ion adsorption and desorption time; leading to increase ion conductivity. Thus, COIM-Bi and/or COIM-Si nanocomposite increases the ionic conductivity between the AA and NCSE. The composite is deposited on the anode array in liquid-phase process followed by heat treatment, and NCC is put on the modified surface by just pressing, without heat treatment. All the fabrication of the battery can be done with conventional ceramic processing equipment in ambient air without the need of dry rooms, vacuum deposition, or glove boxes, dramatically reducing cost of manufacturing.

The flammable organic liquid electrolyte material of conventional battery can be replaced with non-flammable SE that exhibit, for example, at room temperature SE charge particle conductivity of ≥1 Scm⁻¹ and electrochemical stability up to 6V. Moreover, the integration of these composite clay particle electrolyte material in a planar stacked structure with metal collectors will provide battery mechanical strength.

NCSE material, for example, at room temperature (RT) has a Li and Na conductivity of ^{˜}1 Scm⁻¹ and ^{˜}10⁻¹ Scm⁻¹, respectively. Use of scaleable multilayer ceramic fabrication techniques, without need for dry rooms or vacuum equipment, provide dramatically reduced manufacturing cost.

For the all solid battery with no solid electrolyte interface (SEI) performance degradation mechanisms inherent herein described battery, the calendar life of the battery is expected to exceed 10 years and cycle life is expected to exceed 5000 cycles.

The nanoclay is composed of high (nm×μm) aspect ratio ˜1 nm thick aluminosilicate layers intercalated with metal cations, which form ˜10 μm-sized multilayer stacks. In one embodiment, Ce, Li and/or Na atoms and/or cluster complexes were successfully intercalated into interlayer surfaces of aluminosilicate layers. The Basal spacings between aluminosilicate layers increased after intercalation with Ce and subsequent Li/Na cation-exchange, or in another embodiment the further intercalation with Na or Mg. Following the dehydration of the Ce-nanoclay the composite maintained a ˜0.5 nm interlayer spacing; the collasped aluminosilicate layers immobilized the Ce atoms and clusters. The Ce mediated ˜0.5 nm aluminosilicate interlayer spacing allowed for the subsequent ion (ie. Li and/or Na and/or Mg) conduction or ion (ie. Li and/or Na and/or Mg) intercalation/deintercalation in NCE or NCC, respectively. The nano-clay aluminosilicate layers stabilize the intercalate atoms and clusters by limiting their mobility and aggregation. In one embodiment, nano-clay intercalation layer spacing was carried out using small fluoro-molecules (ie. lithium bis(fluorosulfonyl)imide, fluoroethylene carbonate, fluoroethylether, lithium difluoro(oxalato)borate, fluorocyanoesters, 3-fluoroanisol, 2.4 Fluorosilane, 1,1,2,2-tetrafluoroethyl-2,2,3,3-tetrafluoropropyl ether, 4-Fluoro-1,3-dioxolan-2-one, is utilized as a nanoclay conduction spacer.

The ionic conductivity of NCSE is highly correlated to the concentration of the ions in the layered structure. The relationship between the ion conductivity and diffusion coefficient for ion, such as lithium (Li⁺). The conductivity increases with ion content, for example, exhibits a RT conductivity of 1 S/cm. However, conductivity also depends on synthesis conditions, including sintering temperature. The effects of composition and synthesis method can be determined to achieve a minimum RT conductivity of ^{˜}1 S/cm for the scaffold supported NCC and SE.

Due to the powder nature the NCSE can be fabricated using conventional fabrication techniques. This has tremendous advantages in terms of both cost and performance. All the fabrication can be done with conventional ceramic processing equipment in ambient air without the need of dry rooms, vacuum deposition, or glove boxes, dramatically reducing cost of manufacturing.

Moreover, there will be minimal change in overall cell particle dimensions allowing for the battery to be stacked. Light-weight, ^{˜}50 microns thick Al plates will serve not only as collectors but also provide mechanical strength. ^{˜}50 nm of Cu can be electrodeposited on the anode side for electrochemical compatibility with Li metal.

The NCSE solid state chemistry is expected to increase the specific energy density and decrease the cost on the cell level, and also avoid packing material and system cooling engineering requirements.

The theoretical effective specific energy, including structural bipolar plate, is ^{˜}950 Wh/kg. The overpotential at C/3 is negligible compared with the cell voltage, leading to an energy density that is close to theoretical limit. Since the bipolar plate provides strength and no temperature control is necessary for the battery pack other than suitable external packing. The corresponding effective energy density of the complete battery pack is ^{˜}2500 Wh/L.

What is claimed is:

1) A all solid state ion-conducting battery comprising: a) anode array (AA); (b) nano-clay solid electrolyte (NCSE); (c) nano clay cathode (NCC); (d) cyano organic interface material (COIM); (e) and continuity electrodes array (CEA); (f) nano-clay (NC).

2) The solid-state, ion-conducting battery of claim 1, wherein the anode array (AA) is a parallel and/or serially electrically connected copper (Cu) and/or aluminum (Al) printed or patterned circuit board (PCB) array on which is deposited active metal (AM); wherein the AM is Li and/or Na and/or magnesium (Mg) and/or aluminum (Al) and/or iron (Fe) can be deposited.

3) The solid-state, ion-conducting battery of claim 1, the nano-clay of the nano-clay solid electrolyte (NCSE) and the nano clay cathode (NCC), comprises intercalate stabilizing nano-clay, i.e. layered mineral aluminosilicate, that is for example kaolinite and/or bentonite and/or montmorillonite and/or hectorite and/or laponite and/or vermiculite and/or saponite material, etc;

4) The solid-state NCSE of claim 1, the nano-clay can intercalate and/or chelate atomic and/or nano-clusters and/or micro-clusters of cesium (Ce) and/or lithium (Li) and/or sodium (Na) and/or bismuth (Bi) and/or tin (Sn) and/or silicon (Si).

5) The solid-state NCC of claim 1, the nano-clay and organic material can intercalate and/or chelate atomic and/or nano-clusters and/or micro-clusters of tin (Sn) and/or sulfur (S) and/or silicon (Si) and/or bismuth (Bi) and/or cesium (Ce) and/or selenium (Se) and/or Samarium (Sm); and/or halogens, including but not limited to, iodine (I), bromine (Br) and/or chlorine (Cl) and/or lanthanides, including but not limited to, lanthanum (La), and/or Europium (Eu), and/or praseodymium (Pr), and/or neodymium (Nd), and/or Yttrium (Y), gadolinium (Gd) etc.

6) The solid-state, ion-conducting battery of claim 1, the cyano organic interface material (COIM) comprises cyanides, Potassium ferrocyanide, polycyanoacrylate and cyano functionalized polymers/saccarides; which can chelate Ce and/or Li and/or Na and/or Bi and/or Sn and/or Si; the COIM which acts as an interface material between the AA and NCSE; and the NCSE and NCC.

7) The solid-state COIM of claim 1, is redox and thermal stable and increases the ionic conductivity between the AA and NCSE; and the NCSE and NCC.

8) The solid-state, ion-conducting battery of claim 1, the continuity electrodes array (CEA) comprises parallel and/or serially electrically connected printed or patterned or vapor deposited copper (Cu) and/or aluminum (Al) and/or carbon (C) and/or graphene array; which the plurality of CEA provide dendrite electrical continuity detection between the AA and the NCC; or the AA and NCC;

9) The solid-state CEAs and/or AA of claim 1, can be electronically controlled, independently and/or collectively, by computer program(s) to effect continuity detection between the AA and CEA; or the AA and NCC, and to effect AM deposition and redisbursement between AA pads.
